(19) United States
(12) Patent Application Publication
(10) Pub. No.: US 2006/0045602 A1
(43) Pub. Date: Mar. 2, 2006

(54) Mounting arrangement for attaching a stapler to a photocopier

(75) Inventor: Mats Andersson, Mullsjo (SE)

Correspondence Address: MILES & STOCKBRIDGE PC, 1751 PINNACLE DRIVE, SUITE 500, MCLEAN, VA, 22102-3833, US

(73) Assignee: ISABERG RAPID AB, HESTRA (SE)

(21) Appl. No.: 10/531,381

(22) PCT Filed: Sep. 24, 2003
(86) PCT No.: PCT/SE03/01484

§ 371 Date: Apr. 15, 2005

(30) Foreign Application Priority Data
Oct. 15, 2002 (SE) 0203012-0

(51) Int. Cl. B41J 29/02

(52) U.S. Cl. 400/693

(57) ABSTRACT

Mounting arrangement (13) for attaching an electrically powered stapler (5) mechanically and electrically to a photocopying equipment (1) wherein the mounting arrangement (13) comprises a mechanical mounting device (15) for connecting the stapler (5) to the photocopying equipment (1), which mounting device (15) comprises a first attachment piece (16) connected to the stapler and a second attachment piece (17) connected to the photocopying equipment, and an electrical mounting device (26) for connecting the stapler electrically to a power supply (23), which mounting devices (15) and (26) comprising an integrated unit.

### TECHNICAL FIELD

The present invention relates to a mounting arrangement used to connect an electrically driven stapler mechanically and electrically to a photocopying equipment.

### STATE OF THE ART

Mounting arrangements of the type described above are common. An arrangement of this type usually consists of a screwed joint by which the arrangement is mounted in the photocopying equipment and in which the electrical supply is provided by means of separate wiring.

However, previous arrangements suffer from a number of disadvantages. Thus, for example, a large number of manual operations is required when the arrangement is used to mount the stapler in position, and it is usually difficult to free the stapler from the arrangement, due to lack of space, when this is required for servicing or other attention to the stapler. In most cases, considerable dismantling of the photcopier is required to remove the stapler and the space is usually so confined that there is a major risk of poor contact when the electrical supply cable is reconnected repeatedly to the stapler, with the result that the stapler may cease to operate. A further disadvantage is that since the staple magazine must be replenished or replaced at regular intervals, the stapler must be mounted in the photocopying equipment in such manner that its magazine is easily accessible. This means that the photocopying equipment must be provided with such openings as will provide access to the stapler which, in the case of certain photocopying equipment, may be extremely difficult to achieve, depending on the design of the equipment.

### PROBLEMS

There exists, therefore, a need to achieve a mounting arrangement which permits an electrically powered stapler to be connected to and disconnected from a photocopying equipment in a simple and safe manner, and which enables the stapler to be disconnected and reconnected simply repeatedly without creating a risk of poor electrical contact.

### SOLUTION

The present invention overcomes the problems described above by means of a mounting arrangement of the type described in the introduction, which is characterised in that the mounting arrangement comprises a mechanical mounting device for attaching the stapler mechanically to the photocopying equipment, which mounting device comprises a first attachment piece connected to the stapler and a second attachment piece connected to the photocopying equipment, and an electrical mounting device for connecting the stapler electrically to a power supply, which electrical mounting device is integrated with the mechanical mounting device.

The present invention is also characterised in that the mechanical attachment pieces are provided with a guide arrangement comprising guide runners integral with one of the attachment pieces and guide rails integral with the other attachment piece, which guide runners and rails are engaged with each other when the stapler is attached to the photocopying equipment.

The present invention is further characterised in that the mechanical attachment device features a snap-action latch which secures the two attachment pieces to each other when they are assembled together.

The present invention is yet further characterised in that the electrical mounting device comprises a first attachment piece which is connected to one of the mechanical attachment pieces and a second attachment piece which is connected to the second mechanical attachment piece, and that the said first and second attachment pieces become electrically conducting contacts when the mechanical attachment pieces are assembled together.

### BRIEF DESCRIPTION

The invention will hereinafter be described with reference to the appended figures, of which:

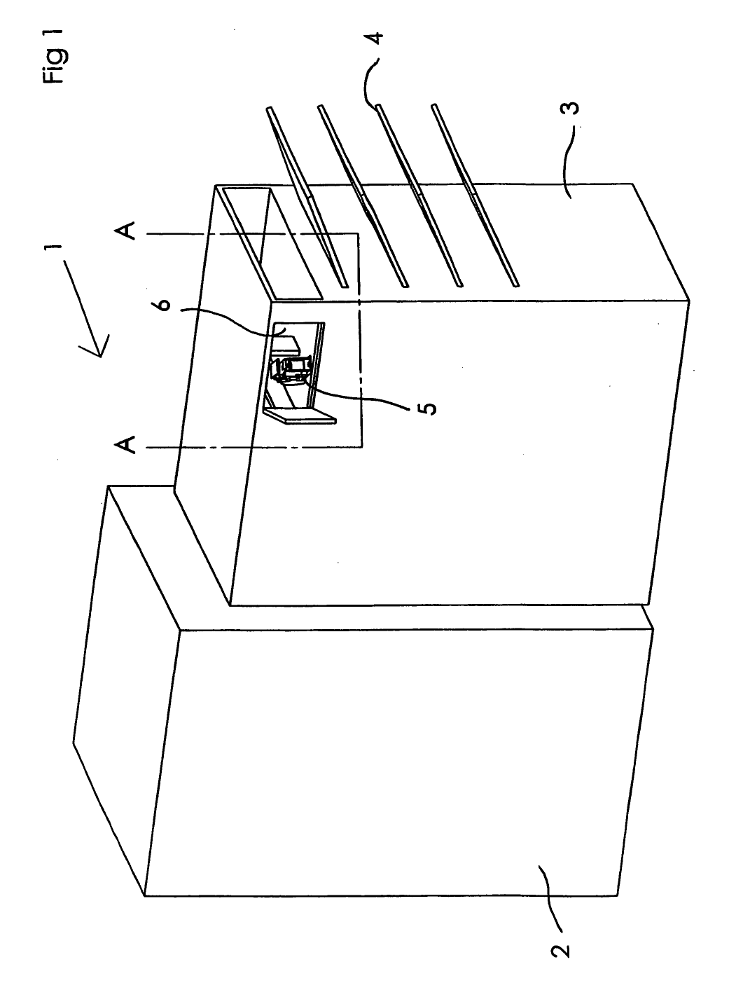

FIG. 1 is a general schematic view of a photocopying equipment;

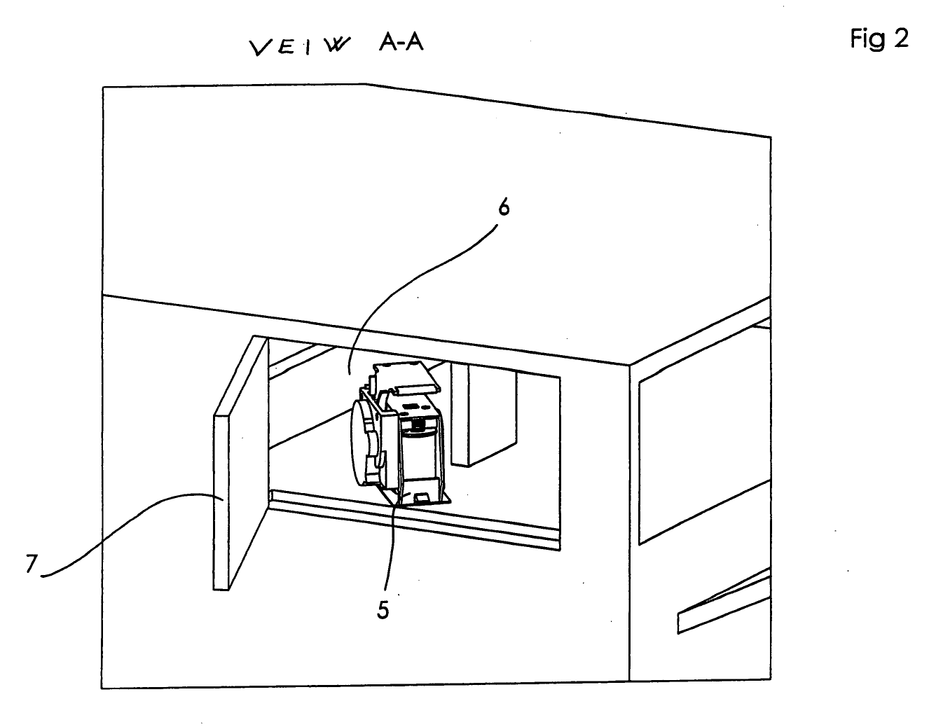

FIG. 2 is a detail view of the section enclosed by the line A-A in FIG. 1;

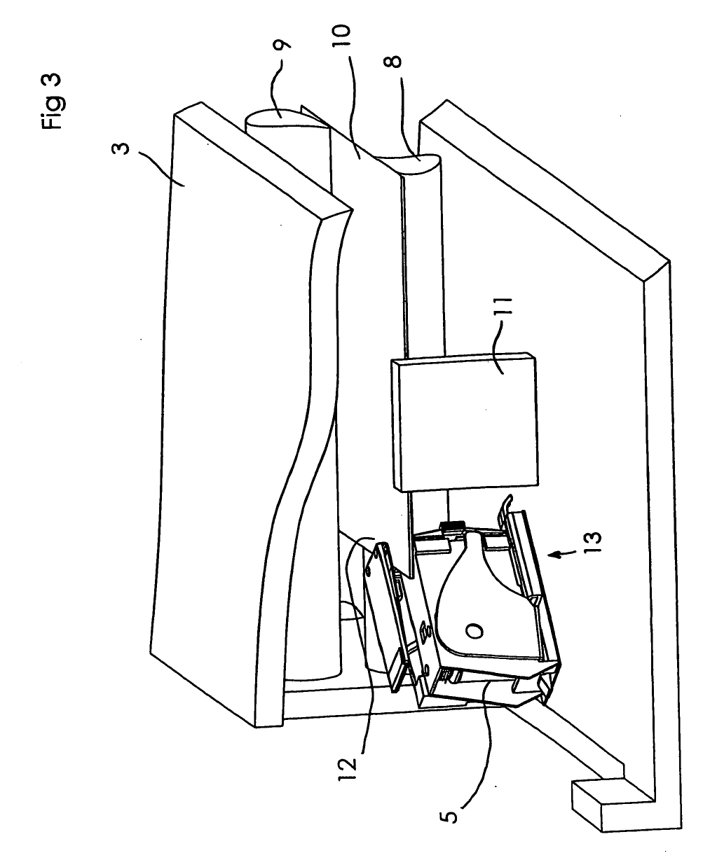

FIG. 3 is a cutaway view of part of a photocopying equipment with a stapler installed;

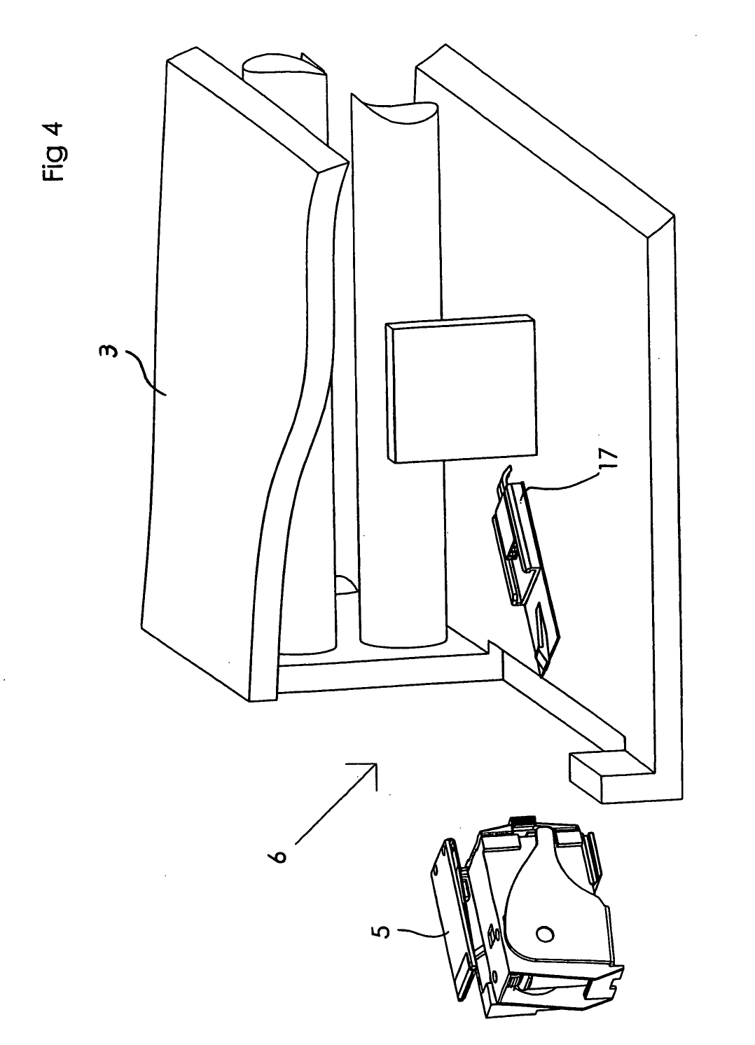

FIG. 4 is a view corresponding to FIG. 3, but with the stapler removed;

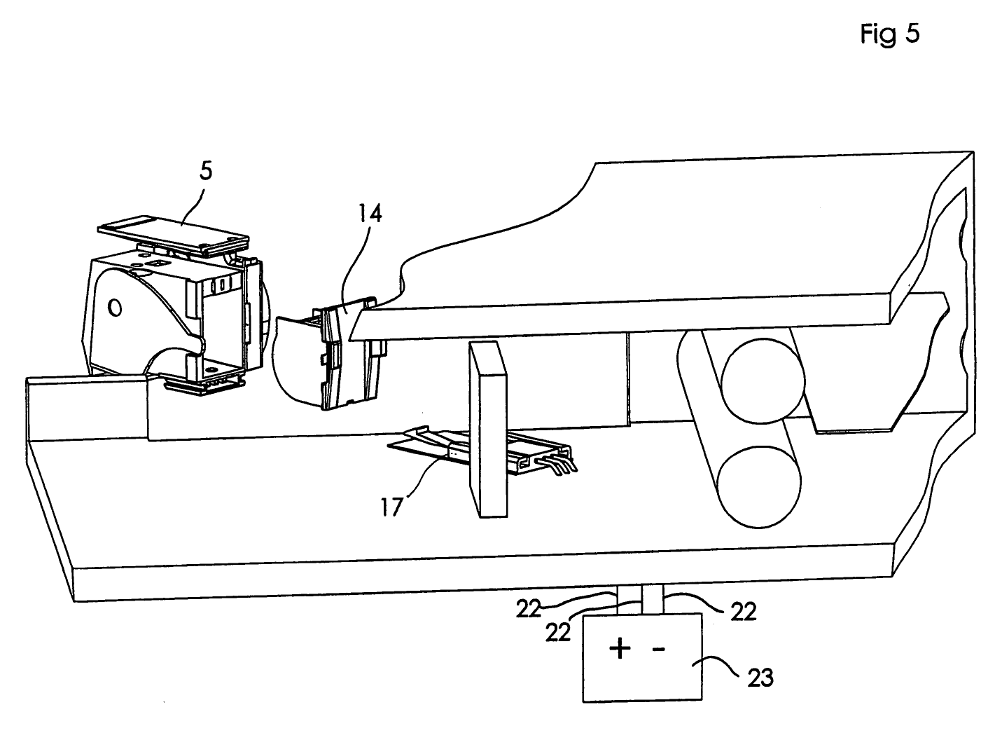

FIG. 5 is a view corresponding to FIG. 4, but viewed from another angle and with the staple magazine removed;

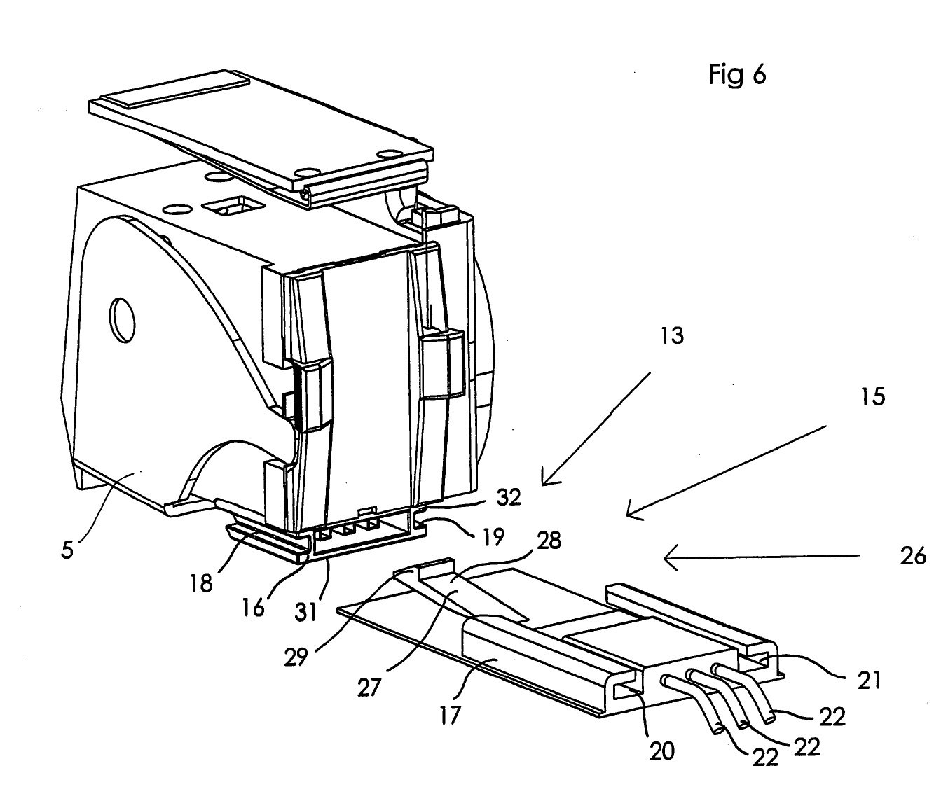

FIG. 6 is a detail view showing a stapler and mounting arrangement in accordance with the present invention prior to mounting;

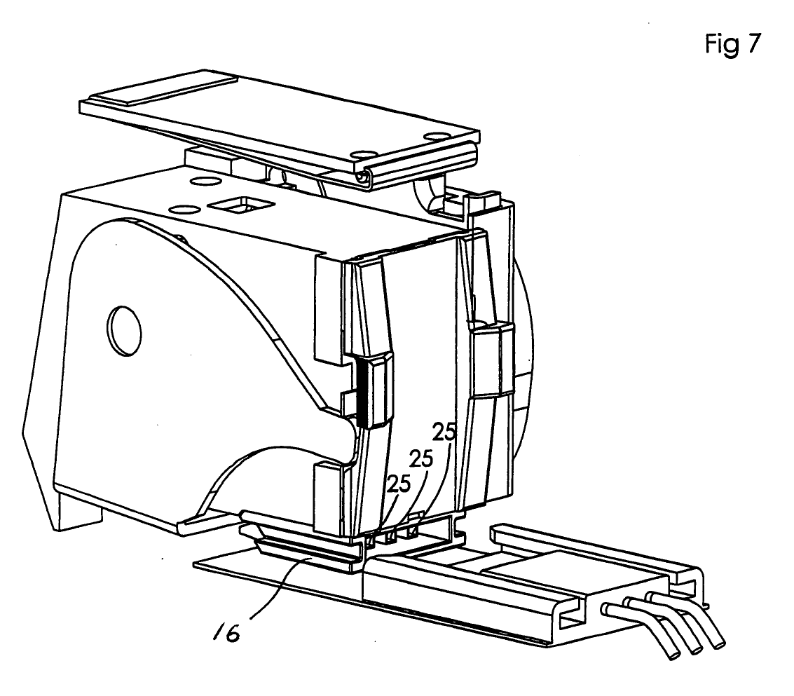

FIG. 7 is a view corresponding to FIG. 6 in which mounting of the arrangement has been commenced;

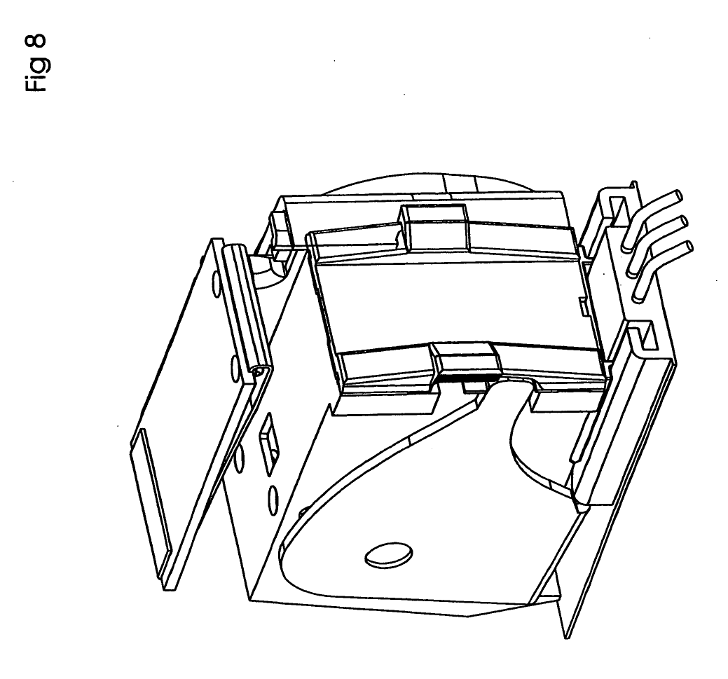

FIG. 8 is a view corresponding to FIG. 6 in which mounting of the arrangement has been completed;

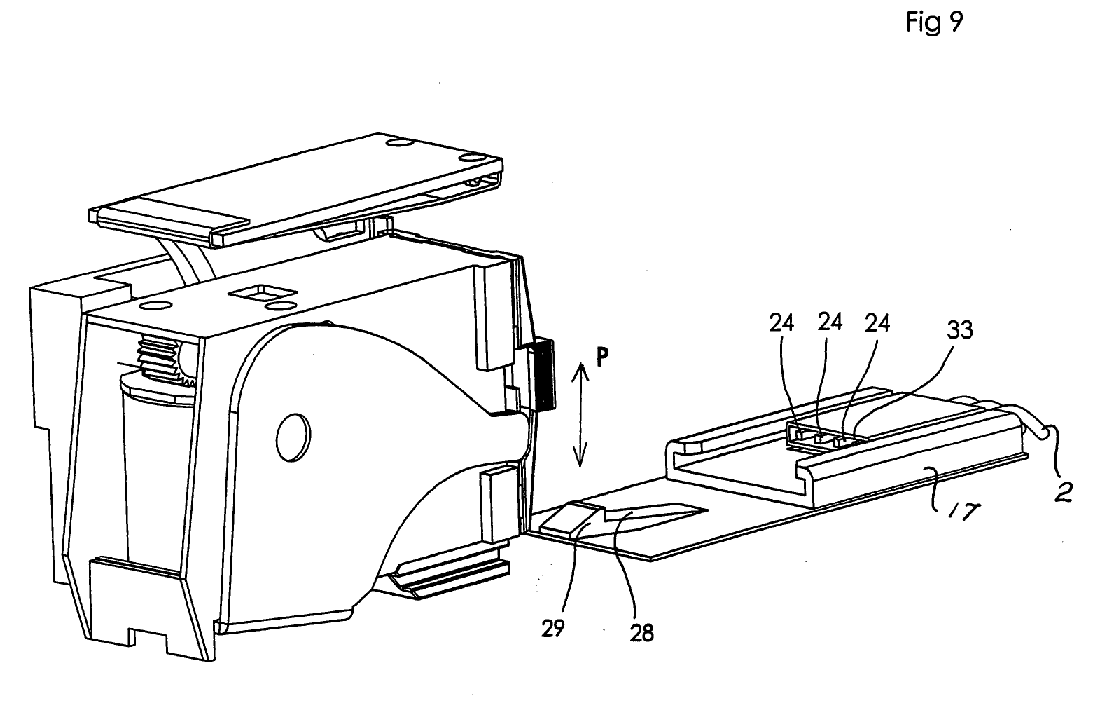

FIG. 9 is a view corresponding to FIG. 6 in which the arrangement is seen obliquely from the rear of the stapler;

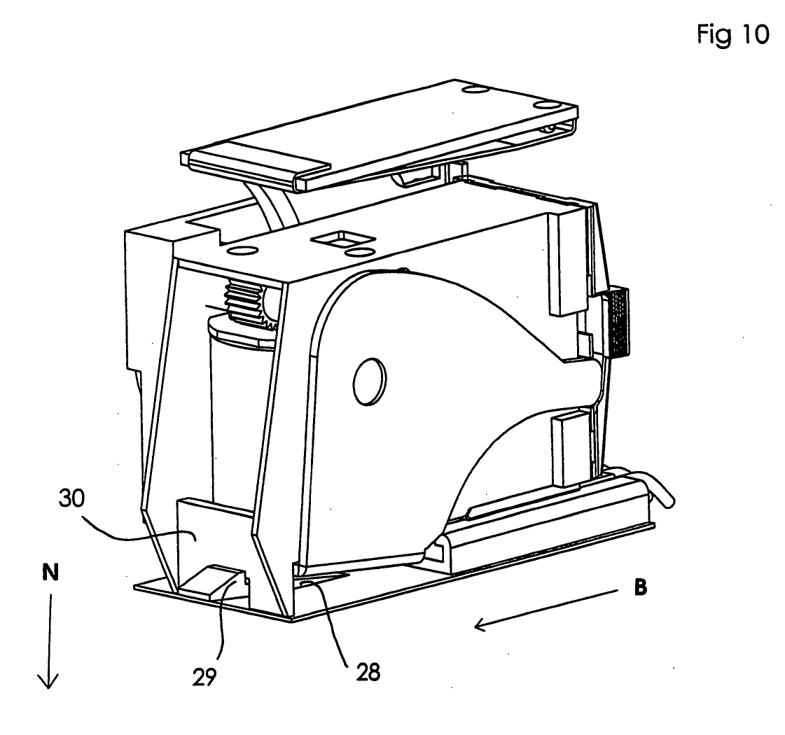

FIG. 10 is a view corresponding to FIG. 8 seen from the same position as in FIG. 9.

### PREFERRED EMBODIMENT

FIGS. 1 and 2 show a photocopying equipment 1 comprising a photocopier 2 and a finisher 3. Copying takes place in the photocopier and the copied sheets of paper are then fed to the finisher, in which they are sorted and stapled before being discharged to trays 4. Since this process is generally known, it will not be described in further detail here. A stapler 5 is mounted in the finisher, which stapler is accessible through an opening 6 in the finisher and which opening 6 can be closed by means of a door 7 on the finisher 3.

FIG. 3 is a cutaway view of the finisher 3, showing that the finisher is equipped with feed rollers 8 and 9, between which a sheet of paper 10 is fed forward to a stop 11. The sheet is fed from the photocopier 2, which is not shown in the figure. Feeding the sheet fully forward to the stop 11 also locates one corner 12 of the sheet in position for stapling by the stapler 5, and stapling is performed in a known manner when a specific number of sheets has been fed forward to the position in question, following which the stapled sheaf can be further discharged in a known manner to one of the trays 4, see FIG. 1. In the figure, the stapler 5 is shown mounted in the finisher 3 by means of a mounting arrangement 13. In FIG. 4, which is a view corresponding to FIG. 3, the stapler 5 is shown detached from the photocopying equipment, in a manner which will be described below, and removed through the opening 6. In FIG. 5, the staple magazine 14 is shown removed from the stapler 5 which, as will easily be seen, can be carried out very easily when the stapler is separated from the photocopying equipment. The mounting arrangement 13 will hereinafter be described in detail with reference to FIGS. 6-10. The mounting arrangement 13 comprises a mechanical mounting device 15 for attaching the stapler 5 mechanically to the photocopying equipment 1. The mounting device 15 comprises a first attachment piece 16, which is connected to the stapler 5, and a second attachment piece 17, which is connected to the photocopying equipment 1, see FIGS. 4 and 5. The attachment piece 16 is provided with a first guide runner 18 and a second guide runner 19, while the second attachment piece 17 is provided with a first guide rail 20 and a second guide rail 21. Electrical leads 22 are connected to the attachment piece 17, which leads are connected to a power supply 23, see FIG. 5. The leads 22 are connected to pins 24 seated in the attachment piece 17. The attachment piece 16 is provided with sleeves 25 corresponding to the pins 24, which sleeves are connected electrically to leads connected to the electric motor housed in the stapler 5 (not shown in the figures). The pins 24 and the sleeves 25 form an electrical mounting device 26 by which the stapler 5 is connected electrically to the photocopying equipment 1. The attachment piece 17 is further provided with a latch 27 provided with an elastically sprung arm 28, which is free to move in the direction indicated by the double arrow P and is provided with an integral catch 29. When the attachment pieces 16 and 17 are engaged in the manner shown in FIG. 10, the catch 29 engages with a latching surface 30 at the rear edge of the stapler 5.

The operation of the mounting arrangement 13 will hereinafter be described with reference to FIGS. 1-10. When mounting a stapler 5 in the photocopying equipment 1, the cover 7 is first opened to provide access to the opening 6. The stapler 5 is passed through the opening 6 and then in the direction of the attachment piece 17. The underside 31 of the attachment piece 16 then meets the catch 29, which springs aside and moves downward in the downward direction of the double arrow P. The stapler is passed further in the direction of the attachment piece 17, and the guide runners 18 and 19 are inserted respectively in the guide rails 20 and 21, while the catch 29 slides along the underside 31. When the stapler is passed further in the direction of the attachment piece 17, the pins 24 enter the sleeves 25 and the stapler is connected electrically. Finally, the stapler is passed sufficiently far to bring a contact face 32 on the attachment piece 16 into contact with a contact face 33 on the attachment piece 17, thereby ensuring that the stapler is located in the correct position. In this position, the arm 28 is free to spring back and the catch 29 grips the latching surface 30 on the stapler, thereby ensuring that the stapler is held in a defined position. To remove the stapler, the catch 29 is depressed in the direction of the arrow N in FIG. 10, releasing the grip of the catch 29 on the latching surface 30 and enabling the stapler to be withdrawn in the direction B shown in FIG. 10 by a distance sufficient to separate the attachment pieces 16 and 17. The stapler can then be removed easily from the photocopying equipment through the opening 6, enabling service or magazine replacement to be carried out simply as and when required.

Although the figures show the guide runners to be integral with the attachment pieces 16 and the guide rails with the attachment piece 17, it will be clear to one skilled in the art that the guide runners may be integrated with the attachment piece 17 and the guide rails with the attachment piece 16 without affecting the invention. Similarly, it is obvious that the pins 24 may be associated with the attachment piece 16 and the sleeves 25 with the attachment piece 17 without altering the invention.

1. Mounting arrangement for attaching an electrically powered stapler mechanically and electrically to a photocopying equipment CHARACTERISED IN THAT the mounting arrangement comprises a mechanical mounting device for connecting the stapler to the photocopying equipment, which mounting device comprises a first attachment piece connected to the stapler and a second attachment piece connected to the photocopying equipment, and an electrical mounting device for connecting the stapler electrically to a power supply, which mounting devices comprising an integrated unit.

2. Mounting arrangement in accordance with claim 1 CHARACTERISED IN THAT the mechanical attachment pieces are provided with a guide arrangement consisting of guide rails integral with one of the attachment pieces and guide runners integral with the other attachment piece and which guide rails and runners engage with each other when the stapler is mounted in the photocopying equipment.

3. Mounting arrangement in accordance with claim 2, CHARACTERISED IN THAT the mechanical mounting device comprises a snap-action latch which secures the two attachment pieces to each other when the said parts are connected.

4. A mounting arrangement in accordance with claim 1, CHARACTERISED IN THAT the electrical mounting device comprises a first connecting part attached to one of the mechanical attachment pieces and a second connecting part attached to the other mechanical attachment piece, and that the said first and second connecting parts are joined to form an electrical connection when the mechanical attachment pieces are assembled together.

5. A mounting arrangement in accordance with claim 2, CHARACTERISED IN THAT the electrical mounting device comprises a first connecting part attached to one of the mechanical attachment pieces and a second connecting part attached to the other mechanical attachment piece, and that the said first and second connecting parts are joined to form an electrical connection when the mechanical attachment pieces are assembled together.

6. A mounting arrangement in accordance with claim 3, CHARACTERISED IN THAT the electrical mounting device comprises a first connecting part attached to one of the mechanical attachment pieces and a second connecting part attached to the other mechanical attachment piece, and that the said first and second connecting parts are joined to form an electrical connection when the mechanical attachment pieces are assembled together.
